(19) United States
(12) Patent Application Publication
(10) Pub. No.: US 2019/0105589 A1
(43) Pub. Date: Apr. 11, 2019

(54) COMPOSITE FILTER MEDIUM COMPRISING WET NONWOVEN FABRIC, AND MANUFACTURING METHOD THEREFOR

(71) Applicant: CLEAN & SCIENCE CO., LTD., Seoul (KR)

(72) Inventor: Jai Joung Moon, Jeonju-si Jeollabuk-do (KR)

(73) Assignee: CLEAN & SCIENCE CO., LTD., Seoul (KR)

(21) Appl. No.: 16/087,954

(22) PCT Filed: Aug. 3, 2016
(86) PCT No.: PCT/KR2016/008558

§ 371 Date: Sep. 24, 2018

(30) Foreign Application Priority Data
Jun. 17, 2016 (KR) 10-2016-0075888

(51) Int. Cl. B01D 39/16; B01D 39/20; D04H 1/4218; D04H 1/555; D04H 1/56

(52) U.S. Cl. CPC B01D 39/1623; D10B 2505/04; D04H 1/4218; D04H 1/555; D04H 1/56; B01D 2239/0618; B01D 2239/0622; B01D 2239/0636; B01D 2239/064; B01D 2239/065; B01D 2239/10; B01D 2239/1233; B01D 2239/1258; B01D 2239/1291; B01D 39/2017

(57) ABSTRACT

An exemplary composite filter medium is disclosed which can include a melt-blown nonwoven fabric layer having a weight of 5 gsm to 40 gsm and include a fiber with a fiber diameter of 1 μm to 3 μm and a wet-laid nonwoven fabric layer located on the melt-blown nonwoven fabric layer, the wet-laid nonwoven fabric layer having a weight of 40 gsm to 100 gsm and including 5 wt % to 30 wt % of a glass fiber with a fiber diameter of 0.1 μm to 2 μm.

### TECHNICAL FIELD

The present invention relates to a composite filter medium manufactured by bonding a melt-blown nonwoven fabric and a wet-laid nonwoven fabric including a glass fiber, and to a method for manufacturing the same. More specifically, the present invention relates to a composite filter medium that has air-vents of optimal size and is capable of preventing a reduction in dust trapping efficiency, and to a method for manufacturing the same.

### BACKGROUND ART

Various devices, such as internal combustion engines, gas turbines, air purifiers, air conditioners, and the like, have air filters installed therein to filter out various kinds of foreign matters contained in air, and the air filters have various types of filter mediums mounted therein as a filtration medium. The filter mediums mounted in the air filters filter out various kinds of foreign matters contained in air that is supplied to operate the devices, thereby ensuring normal operations of the devices and extending the lifetime of the devices. Therefore, the filter mediums need to have both high filtration efficiency in effectively trapping foreign matters and long filtration life. However, in order to trap various kinds of foreign matters in air, the filter mediums need to have fine air-vents formed therein. If so, the air-vents are closed early, which causes a reduction in filtration life of the filter mediums.

In contrast, if the filter mediums have air-vents large in size, the filtration life of the filter mediums is extended, whereas fine foreign matters pass through the air-vents, which leads to a significant decrease in filtration efficiency of the filter mediums.

Filter paper or nonwoven fabric is widely used as the air filter mediums. Especially, a melt-blown nonwoven fabric is generally used as filter paper for an air filter. The melt-blown nonwoven fabric is a self-defective nonwoven fabric that is generally produced by extruding a thermoplastic resin to form long thin fibers, passing hot air over the fibers at high speed to make ultra-fine fibers, and stacking the ultra-fine fibers on a collector.

The melt-blown nonwoven fabric is pleated to maximize efficiency. However, due to its flexible nature, the melt-blown nonwoven fabric has poor morphological stability after being pleated. That is, the melt-blown nonwoven fabric has a strong tendency to return to its original shape after the pleating without maintaining the pleated shape. Therefore, the melt-blown nonwoven fabric has the following problems: low contact ability between air and a filter, low filter efficiency, and serious pressure loss.

Accordingly, a spunbond nonwoven fabric is generally laminated on the melt-blown nonwoven fabric to maintain the shape of the melt-blown nonwoven fabric.

A filter medium having a spunbond nonwoven fabric and a melt-blown nonwoven fabric laminated on each other is advantageous in that the shape is uniformly maintained and filtration efficiency is excellent, but is not cost-effective in that the filter medium has to be frequently replaced due to a short usage cycle caused by a rapid drop in efficiency on account of a reduction in electrostatic force.

Furthermore, when a spunbond nonwoven fabric is used as a nonwoven fabric for a filter medium that is bonded with a melt-blown nonwoven fabric, the filter medium generally has fine air-vents to increase filtration efficiency. However, the filtration life of the filter medium according to periodic use decreases with a reduction in size of the air-vents in the filter medium.

Accordingly, studies on a filter medium for air purification that effectively traps foreign matters and has long filtration life have been conducted in various fields.

### SUMMARY OF INVENTION

### Technical Problem

Accordingly, the present invention has been made keeping in mind the above problems occurring in the related art, and is intended to provide a filter medium and a method for manufacturing the same, the filter medium having a melt-blown nonwoven fabric and a wet-laid nonwoven fabric that includes a glass fiber and that is bonded to the melt-blown nonwoven fabric, thereby achieving a high ability to maintain a shape, constant filtration efficiency, and long filtration life. Technical problems that are to be solved by the present invention are not limited to the above-mentioned aspect, and other technical aspects that are not mentioned herein will be clearly understood by those skilled in the art from the following description.

### Solution to Problem

In accordance with an aspect of the present invention, a composite filter medium includes a melt-blown nonwoven fabric layer having a weight of 5 gsm to 40 gsm and including a fiber with a fiber diameter of 1 μm to 3 μm and a wet-laid nonwoven fabric layer located on the melt-blown nonwoven fabric layer, the wet-laid nonwoven fabric layer having a weight of 40 gsm to 100 gsm and including 5 wt % to 30 wt % of a glass fiber with a fiber diameter of 0.1 μm to 2 μm.

According to an embodiment, the wet-laid nonwoven fabric layer may further include one or more of a polypropylene fiber, a polyethylene terephthalate fiber, an acrylic fiber, and a nylon fiber.

According to an embodiment, the wet-laid nonwoven fabric layer may further include one or more of a low-melting fiber and a tackifier resin.

According to an embodiment, the wet-laid nonwoven fabric layer may have efficiency of 30% to 80% in trapping fine particles with a diameter of 0.1 mm to 0.5 mm.

According to an embodiment, the composite filter medium may have efficiency of not less than 90% and not more than 99.99% in trapping fine particles with a diameter of 0.1 mm to 0.5 mm and may have filtration efficiency of 50% to 95% after the composite filter medium is processed with isopropyl alcohol (IPA).

In accordance with another aspect of the present invention, a method for manufacturing a composite filter medium includes: (a) a step for cutting a glass fiber, a polyethylene terephthalate fiber, and a low-melting fiber into respective fiber chops; (b) a step for preparing a first mixture by mixing the respective fiber chops; (c) a step for forming a slurry by beating the first mixture and then forming a sheet by wet laying the slurry; (d) a step for forming a wet-laid nonwoven fabric by pressing the sheet; and (e) a step for bonding the wet-laid nonwoven fabric to a surface of a melt-blown nonwoven fabric. The melt-blown nonwoven fabric has a weight of 5 gsm to 40 gsm, and the wet-laid nonwoven fabric has a weight of 40 gsm to 100 gsm.

According to an embodiment, in step (c), one or more of a dispersing agent, an antifoaming agent, and a thickener may be added to the slurry.

According to an embodiment, in step (e), the bonding may be performed by one or more of hot melt bonding, ultrasonic bonding, and chemical bonding.

### Advantageous Effects of Invention

According to the embodiments of the present invention, the composite filter medium, which includes the melt-blown nonwoven fabric and the wet-laid nonwoven fabric including a glass fiber, can achieve high filtration efficiency and long filtration life by optimally adjusting the size of filtration air-vents. Thus, the composite filter medium can be effectively used to purify air in various devices, such as internal combustion engines, gas turbines, air purifiers, air conditioners, and the like.

The effects of the present invention are not limited to the above-mentioned effect, and other effects that are not mentioned herein will be clearly understood by those skilled in the art from the following claims.

### BRIEF DESCRIPTION OF DRAWINGS

FIG. 1 is a cross-sectional view of a composite filter medium according to an embodiment of the present invention.

FIG. 2 is a flowchart illustrating a method for manufacturing a composite filter medium including a wet-laid nonwoven fabric, according to an embodiment of the present invention.

### DESCRIPTION OF EMBODIMENTS

Hereinafter, embodiments of the present invention will be described in detail with reference to the accompanying drawings. However, it is to be noted that the present invention is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “indirectly connected or coupled to” another element via still another element. Further, through the whole document, the term “comprises” or “includes” and/or “comprising” or “including” used in the document means that one or more other components, steps, operation and/or existence or addition of elements are not excluded in addition to the described components, steps, operation and/or elements unless context dictates otherwise.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

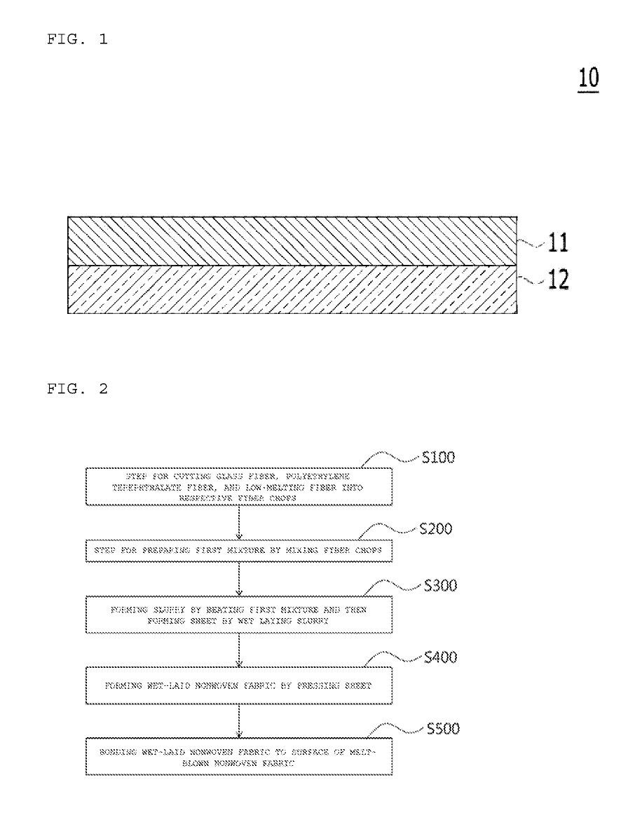

FIG. 1 is a cross-sectional view of a composite filter medium.

Referring to FIG. 1, the composite filter medium includes a melt-blown nonwoven fabric layer having a weight of 5 gsm to 40 gsm and including a fiber with a fiber diameter of 1 μm to 3 μm and a wet-laid nonwoven fabric layer 11 located on the melt-blown nonwoven fabric layer, the wet-laid nonwoven fabric layer having a weight of 40 gsm to 100 gsm and including 5 wt % to 30 wt % of a glass fiber with a fiber diameter of 0.1 μm to 2 μm.

In particular, the melt-blown nonwoven fabric layer may be located in an air outflow part, and the wet-laid nonwoven fabric layer may be located in an air inflow part.

In the present invention, air flow means that air filtered through the air inflow part flows the air outflow part.

The term “fiber diameter” used herein refers to the diameter of a fiber.

When the melt-blown nonwoven fabric has a weight of less than 5 gsm, there is a limit to form a melt-blown fiber diameter within a desired range, and when the melt-blown nonwoven fabric has a weight of more than 40 gsm, there is a problem in that pressure loss of the melt-blown nonwoven fabric sharply increases.

In addition, when the weight of the melt-blown nonwoven fabric exceeds 40 gsm, manufacturing cost of the composite filter medium also increases. Therefore, the melt-blown nonwoven fabric may preferably have a weight of 5 gsm to 40 gsm.

In the present invention, the melt-blown nonwoven fabric layer may be a composite filter medium that includes a polypropylene fiber with a fiber diameter of 0.5 μm to 3 μm.

In addition, the wet-laid nonwoven fabric layer may be a composite filter medium that further includes one or more of a polypropylene fiber, a polyethylene terephthalate fiber, an acrylic fiber, and a nylon fiber.

The wet-laid nonwoven fabric of the present invention may have various types of fibers added thereto, in addition to the aforementioned fibers. For instance, examples of the fibers may be one or more selected from a group consisting of a polyethylene fiber, a polypropylene fiber, a polybutylene fiber, a terephthalate fiber, a polyamide fiber, a polyurethane fiber, a polybutene fiber, a poly lactic acid fiber, a polyvinyl alcohol fiber, a poly phenylene sulfide fiber, a polyacrylonitrile fiber, a polyester fiber, a glass fiber, an aramid fiber, a ceramic fiber, a metal fiber, a polyimide fiber, a poly benz oxazole fiber, a natural fiber, and a combinations thereof.

Especially, the polyester fiber includes, but not limited to, polyethylene terephthalate (PET), polyglycolide (PGA), poly lactic acid (PLA), polycaprolactone (PCL), polyhydroxyalkanoate (PHA), polyhydroxybutyrate (PHB), polyethylene adipate (PEA), polybutylene succinate (PBS), poly(3-hydroxybutyrate-co-3-hydroxyvalerate) (PHBV), polybutylene terephthalate (PBT), polytrimethylene terephthalate (PTT), polyethylene naphthalate (PEN), and Vectran.

Furthermore, the wet-laid nonwoven fabric layer may be a composite filter medium that further includes one or more of a low-melting fiber and a tackifier resin.

The low-melting fiber refers to a fiber having a melting point of 100° C. to 180° C. The low-melting fiber is added to the wet-laid nonwoven fabric layer to increase bonding strength between fibers in the wet-laid nonwoven fabric.

The low-melting fiber may refer to one or more of a low-melting polyethylene terephthalate fiber, a low-melting polypropylene fiber, a low-melting polyethylene fiber, and a fiber having a melting point of 100° C. to 180° C.

In addition, the tackifier resin is a resin for increasing tensile strength, internal tearing strength, disruptive strength, frictional strength, and abrasion strength of the wet-laid nonwoven fabric by raising the stickiness in the wet-laid nonwoven fabric.

Ultimately, the tackifier resin is added to increase the durability of the wet-laid nonwoven fabric layer. The tackifier resin includes, but not limited to, an acrylic resin, a PVAC resin, a phenolic resin, and a novolac resin.

In the present invention, the wet-laid nonwoven fabric layer may have efficiency of 30% to 80% in trapping fine particles with a diameter of 0.1 mm to 0.5 mm.

In addition, the composite filter medium may have efficiency of not less than 90% and not more than 99.99% in trapping fine particles with a diameter of 0.1 mm to 0.5 mm and may have filtration efficiency of 50% to 95% after the composite filter medium is processed with isopropyl alcohol (IPA) to find out filtration efficiency after removal of static electricity.

FIG. 2 is a flowchart illustrating a method for manufacturing a composite filter medium including a wet-laid nonwoven fabric according to an embodiment of the present invention. According to an embodiment, the composite filter medium manufacturing method may include: a step S100 for cutting a glass fiber, a polyethylene terephthalate fiber, and a low-melting fiber into respective fiber chops; a step S200 for preparing a first mixture by mixing the respective fiber chops; a step S300 for forming a slurry by beating the first mixture and then forming a sheet by wet laying the slurry; a step S400 for forming a wet-laid nonwoven fabric by pressing the sheet; and a step S500 for bonding the wet-laid nonwoven fabric to a surface of a melt-blown nonwoven fabric. The melt-blown nonwoven fabric may have a weight of 5 gsm to 40 gsm, and the wet-laid nonwoven fabric may have a weight of 40 gsm to 100 gsm.

The term “chops” used herein is also referred to as “staple fibers” Short fibers obtained by cutting a fiber to a predetermined length are defined as chop fibers or simply chops.

In this case, the respective fiber chops, into which the glass fiber, the polyethylene terephthalate fiber, and the low-melting fiber are cut, may have a length of 1 mm to 300 mm and a diameter of 0.01 De to 5 De.

De (Denier) is a unit used to indicate the thickness of a fiber that means a fiber diameter (fineness). 1 Denier means the thickness of a 9000-meter-long fiber made from yarn of 1 g.

The term “beating” used herein refers to a process of uniformly forming a slurry while dissociating and dispersing a fiber.

The term “slurry” used herein refers to a high-concentration suspension that has fiber chops physically dispersed in water.

The term “web” used herein refers to a group of chops in a slurry form that float in water.

In one embodiment of the present invention, one or more of a dispersing agent, an antifoaming agent, and a thickener may be added to the slurry.

Referring to FIG. 2, to achieve the technical objective, respective fiber chops are prepared by cutting a glass fiber, a polyethylene terephthalate fiber, and a low-melting fiber (S100).

The fiber chops constituting a wet-laid nonwoven fabric of the present invention may include various types of fiber chops and may be applied to, for example, one or more selected from a group consisting of a polyethylene terephthalate fiber, a polyethylene fiber, a polypropylene fiber, a polybutylene fiber, a terephthalate fiber, a polyamide fiber, a polyurethane fiber, a polybutene fiber, a poly lactic acid fiber, a polyvinyl alcohol fiber, a poly phenylene sulfide fiber, a polyacrylonitrile fiber, a polyester fiber, a glass fiber, an aramid fiber, a ceramic fiber, a metal fiber, a polyimide fiber, a poly benz oxazole fiber, a natural fiber, or a combinations thereof.

Especially, the polyester fiber includes, but not limited to, polyethylene terephthalate (PET), polyglycolide (PGA), poly lactic acid (PLA), polycaprolactone (PCL), polyhydroxyalkanoate (PHA), polyhydroxybutyrate (PHB), polyethylene adipate (PEA), polybutylene succinate (PBS), poly(3-hydroxybutyrate-co-3-hydroxyvalerate) (PHBV), polybutylene terephthalate (PBT), polytrimethylene terephthalate (PTT), polyethylene naphthalate (PEN), and Vectran.

After the preparation of the fiber chops, a first mixture is prepared by mixing the respective fiber chops (S200).

The first mixture is prepared by mixing the glass fiber chops, the polyethylene terephthalate fiber chops, and the low-melting polyethylene terephthalate fiber chops (S200). In this case, the glass fiber chops, the polyethylene terephthalate fiber chops, and the low-melting polyethylene terephthalate fiber chops may have a length of 1 mm to 300 mm and a diameter of 0.01 De to 5 De. The amount of the fiber glass chops and the amount of the polyethylene terephthalate fiber chops may be 5 wt % to 50 wt %, and the amount of the low-melting fiber chops may be 40 wt % to 60 wt %.

TABLE 1

| | Glass | PET | LM PET | PET | PET |
|---|---|---|---|---|---|
| Classification | Fiber | 3D | 1.1D | 1.4D | 0.4D |
| Mixing Ratio 1 | 13 | 37 | 50 | — | — |
| Mixing Ratio 2 | 12 | 38 | 50 | — | — |
| Mixing Ratio 3 | 15 | 35 | 50 | — | — |
| Mixing Ratio 4 | 20 | 25 | 40 | 15 | — |
| Mixing Ratio 5 | 13 | 22 | 50 | — | 15 |
| Mixing Ratio 6 | 10 | 20 | 40 | — | 30 |
| Mixing Ratio 7 | 13 | 15 | 45 | — | 27 |

(PET: polyethylene terephthalate, LM PET: low-melting polyethylene terephthalate)
(De: Denier)

Table 1 shows the composition of glass-fiber wet-laid nonwoven fabrics according to fiber mixing ratios.

TABLE 2

| | Mix- | Mix- | Mix- | Mix- | Mix- | Mix- | Mix- |
|---|---|---|---|---|---|---|---|
| | ing | ing | ing | ing | ing | ing | ing |
| | Ratio | Ratio | Ratio | Ratio | Ratio | Ratio | Ratio |
| Classification | 1 | 2 | 3 | 4 | 5 | 6 | 7 |
| Differential | 4.0 | 3.0 | 6.6 | 17.7 | 3.0 | 2.7 | 5.2 |
| Pressure (mmAq) | | | | | | | |
| Filtration | 63 | 58 | 77 | 66.9 | 41.4 | 42.8 | 76.4 |
| Efficiency (%) | | | | | | | |

Table 2 shows filtration efficiencies according to the mixing ratios in Table 1.

TABLE 3

| | Differential | Filtration |
|---|---|---|
| Wet-laid (weight) | Pressure (mmAq) | Efficiency (%) |
| 60 g/m² | 4.0 | 63 |
| 70 g/m² | 5.0 | 68 |
| 78 g/m² | 7.5 | 72 |

Table 3 shows results obtained by conducting an analysis of filtration efficiency, with a difference only in weight with respect to “Mixing Ratio 1” (13 wt % of glass fiber, 37 wt % of PET 3D, and 50 wt % of LM PET 1.1D).

TABLE 4

| | Differential | Filtration | Basis |
|---|---|---|---|
| Classification | Pressure (mmAq) | Efficiency (%) | Weight (gsm) |
| MB (Melt-blown | 1.0 | 97 | 10 |
| nonwoven fabric) | | | |
| MB + Wet-laid 1. | 3.3 | 98 | 66 |
| MB + Wet-laid 2. | 3.6 | 98.5 | 70 |
| MB + Wet-laid 3. | 4.3 | 99 | 76 |

Table 4 shows analysis results on filtration efficiencies of a melt-blown nonwoven fabric itself and composite filter mediums made of the melt-blown nonwoven fabric and wet-laid nonwoven fabrics with the mixing ratios 1 to 3. It can be seen that the filtration efficiencies of the composite filter mediums having the wet-laid nonwoven fabrics were measured to be higher than that of the simple melt-blown nonwoven fabric.

TABLE 5

| | | | | Filtration |
|---|---|---|---|---|
| | | | | Efficiency |
| | | | | (%) after |
| | Differential | Filtration | Basis | Removal |
| | Pressure | Efficiency | Weight | of Static |
| Classification | (mmAq) | (%) | (gsm) | Electricity |
| MB | 1.0 | 97 | 10 | 20 |
| MB + Wet-laid 1. | 3.3 | 98 | 66 | 54.3 |
| MB + Wet-laid 2. | 3.6 | 98.5 | 70 | 56 |
| MB + Wet-laid 3. | 4.3 | 99 | 76 | 72 |

Table 5 shows results obtained by conducting a comparative analysis of filtration efficiencies after electrostatic force after the first filtration was removed by an antistatic method using isopropyl alcohol (IPA). It can be seen that the filtration efficiency of the melt-blown nonwoven fabric itself having undergone an antistatic process was sharply decreased so that the life cycle of the melt-blown nonwoven fabric, as a filter medium, was short.

However, it can be seen that, even after the removal of static electricity, the composite filter mediums having the wet-laid nonwoven fabrics, unlike the existing melt-blown nonwoven fabric, still had filtration efficiencies of a predetermined level or higher, with differences only by the mixing ratios.

Slurry is formed by beating the first mixture, and then a sheet is formed by wet laying the slurry. In this case, a fabric may be formed by pressing the sheet, and a melt-blown nonwoven fabric may be bonded to a surface of the fabric (S300).

The wet laying method in S300 includes a first step for forming a web by allowing the slurry to rise to the surface of water using horizontal vibration and a second step for preparing a sheet by skimming and drying the web.

In this case, one or more of a dispersing agent, an antifoaming agent, and a thickener may be added to the slurry.

After the wet laying process, a wet-laid nonwoven fabric is formed by pressing the prepared sheet (S400).

A filter medium is manufactured by bonding the wet-laid nonwoven fabric to a surface of a melt-blown nonwoven fabric (S500).

The bonding of the melt-blown nonwoven fabric and the wet-laid nonwoven fabric including a glass fiber may be performed by a well-known bonding method, such as hot melt bonding, ultrasonic bonding, chemical bonding, heat treatment after needle punching, or the like, and the filter medium may be manufactured by using the aforementioned bonding methods together if necessary.

The above description of the present invention is provided for the purpose of illustration, and it would be understood by those skilled in the art that various changes and modifications may be made without changing the technical conception and essential features of the present invention. Thus, it is clear that the above-described embodiments are illustrative in all aspects and do not limit the present invention. For example, each component described to be of a single type can be implemented in a distributed manner. Likewise, components described to be distributed can be implemented in a combined manner.

The scope of the present invention is defined by the following claims rather than by the detailed description of the embodiment. It shall be understood that all modifications and embodiments conceived from the meaning and scope of the claims and their equivalents are included in the scope of the present invention.

1. A composite filter medium, comprising:
a melt-blown nonwoven fabric layer having a weight of 5 gsm to 40 gsm and having fiber with a fiber diameter of 1 μm to 3 μm; and
a wet-laid nonwoven fabric layer located on the melt-blown nonwoven fabric layer, the wet-laid nonwoven fabric layer having a weight of 40 gsm to 100 gsm and having 5 wt % to 30 wt % of a glass fiber with a fiber diameter of 0.1 μm to 2 μm.

2. The composite filter medium of claim 1, wherein the wet-laid nonwoven fabric layer comprises:
one or more of a polypropylene fiber, a polyethylene terephthalate fiber, an acrylic fiber, and a nylon fiber.

3. The composite filter medium of claim 1, wherein the wet-laid nonwoven fabric layer comprises:
one or more of a low-melting fiber and a tackifier resin.

4. The composite filter medium of claim 1, wherein the wet-laid nonwoven fabric layer has an efficiency of 30% to 80% in trapping fine particles with a diameter of 0.1 mm to 0.5 mm.

5. The composite filter medium of claim 1, wherein the composite filter medium has an efficiency of not less than 90% and not more than 99.99% in trapping fine particles with a diameter of 0.1 mm to 0.5 mm, and has filtration efficiency of 50% to 95% after the composite filter medium is processed with isopropyl alcohol (IPA).

6. A method for manufacturing a composite filter medium, the method comprising:
(a) cutting a glass fiber, a polyethylene terephthalate fiber, and a low-melting fiber into respective fiber chops;
(b) preparing a first mixture by mixing the respective fiber chops;
(c) forming a slurry by beating the first mixture and then forming a sheet by wet laying the slurry;
(d) forming a wet-laid nonwoven fabric by pressing the sheet; and
(e) bonding the wet-laid nonwoven fabric to a surface of a melt-blown nonwoven fabric, wherein the melt-blown nonwoven fabric has a weight of 5 gsm to 40 gsm, and the wet-laid nonwoven fabric has a weight of 40 gsm to 100 gsm.

7. The method of claim 6, comprising:
forming the slurry by adding one or more of a dispersing agent, an antifoaming agent, and a thickener to the slurry.

8. The method of claim 6, comprising:
performing the bonding by one or more of hot melt bonding, ultrasonic bonding, and chemical bonding.
